(19) United States
(12) Patent Application Publication
(10) Pub. No.: US 2015/0195037 A1
(43) Pub. Date: Jul. 9, 2015

(54) OPTICAL INTERCONNECTION DEVICE TRANSMITTING DATA PATTERN USING COMPLEMENTARY SIGNALS, MEMORY SYSTEM COMPRISING SAME, AND RELATED METHOD OF OPERATION

(71) Applicant: SAMSUNG ELECTRONICS CO., LTD., Suwon-si (KR)

(72) Inventors: AMIR HOSSEIN NEJADMALAYERI, HWASEONG-SI (KR); YOON-DONG PARK, OSAN-SI (KR)

(21) Appl. No.: 14/559,677

(22) Filed: Dec. 3, 2014

(30) Foreign Application Priority Data
Jan. 7, 2014 (KR) 10-2014-0001674

(51) Int. Cl. H04B 10/25; H04J 14/06

(52) U.S. Cl. CPC H04B 10/2504; H04J 14/06

(57) ABSTRACT

An optical interconnection device comprises a transmitter, and optical waveguide, and a receiver. The transmitter is configured to generate first transmission light with a first data pattern and second transmission light with a second data pattern, the first and second data patterns being derived from an original data pattern, the first transmission light being linearly polarized with a first polarization, the second transmission light being linearly polarized with a second polarization orthogonal to the first polarization, and the first and second data patterns being complementary to each other. The optical waveguide is configured to communicate the first transmission light and the second transmission light concurrently. The receiver is configured to receive first reception light corresponding to the first transmission light and second reception light corresponding to the second transmission light through the optical waveguide.

### CROSS-REFERENCE TO RELATED APPLICATION

This application claims priority under 35 USC §119 to Korean Patent Application No. 10-2014-0001674 filed on Jan. 7, 2014, the disclosure of which is hereby incorporated by reference in its entirety.

### BACKGROUND OF THE INVENTION

The inventive concept relates generally to optical communication, and more particularly to an optical interconnection device transmitting a data pattern using complementary signals, and a memory system comprising the same.

As operating speeds of semiconductor devices are increased, operating speeds of related interconnections, such as buses, may need to increase accordingly. For example, in a high speed memory system, the operating speed of a memory bus may be required to increase to connect a high-speed memory controller to a high speed memory device. Where the memory bus is implemented with an electrical channel, increases in operating speed may be limited by undesired effects such as signal distortion, noise, delay, etc., which can decrease reliability of the transmitted signals.

To avoid these and other limitations of electrical channels, researchers are developing optical communication buses, which communicate via optical channels. Optical communication buses may potentially increase the speed and reliability of transferred data because optical signals may experience less interference than electrical signals. Nevertheless, optical communication buses also have significant drawbacks. For instance, they may require a substantial amount of power to ensure reliable optical communication, or they may require undesirably large circuit structures to communicate with lower power.

### SUMMARY OF THE INVENTION

In one embodiment of the inventive concept, an optical interconnection device comprises a transmitter, and optical waveguide, and a receiver. The transmitter is configured to generate first transmission light with a first data pattern and second transmission light with a second data pattern, the first and second data patterns being derived from an original data pattern, the first transmission light being linearly polarized with a first polarization, the second transmission light being linearly polarized with a second polarization orthogonal to the first polarization, and the first and second data patterns being complementary to each other. The optical waveguide is configured to communicate the first transmission light and the second transmission light concurrently. The receiver is configured to receive first reception light corresponding to the first transmission light and second reception light corresponding to the second transmission light through the optical waveguide.

In another embodiment of the inventive concept, a memory system comprises a memory controller, one or more memory modules, and one or more optical interconnection devices each comprising a transmitter, an optical waveguide, and a receiver. The transmitter is configured to generate first transmission light with a first data pattern and second transmission light with a second data pattern, the first and second data patterns being derived from an original data pattern, the first transmission light being linearly polarized with a first polarization, the second transmission light being linearly polarized with a second polarization orthogonal to the first polarization, and the first and second data patterns being complementary to each other. The optical waveguide is configured to communicate the first transmission light and the second transmission light concurrently. The receiver is configured to receive first reception light corresponding to the first transmission light and second reception light corresponding to the second transmission light through the optical waveguide.

In another embodiment of the inventive concept, a method comprises generating first transmission light with a first data pattern and second transmission light with a second data pattern, the first and second data patterns being derived from an original data pattern, the first transmission light being linearly polarized with a first polarization, the second transmission light being linearly polarized with a second polarization orthogonal to the first polarization, and the first and second data patterns being complementary to each other, communicating the first transmission light and the second transmission light concurrently through an optical waveguide, and receiving first reception light corresponding to the first transmission light and second reception light corresponding to the second transmission light through the optical waveguide.

In these and other embodiments of the inventive concept, an optical interconnection device, a memory system, and method may reduce power consumption by enhancing the modulation efficiency of a transmitter. Reliability of transferred signals may be enhanced by adopting complementary signaling, and the burst mode transfer of the memory system may be performed without additional data encoding. Furthermore the number of channels may be reduced by performing the complementary signaling using one optical waveguide, thereby realizing low-power and high-reliability optical communication without increasing the system size and the design burden.

### BRIEF DESCRIPTION OF THE DRAWINGS

The drawings illustrate selected embodiments of the inventive concept. In the drawings, like reference labels denote like features.

FIG. 1 is a diagram illustrating an optical interconnection device according to an embodiment of the inventive concept.

FIG. 2 is a diagram illustrating a complementary signaling scheme of the optical interconnection device of FIG. 1.

FIG. 3 is a diagram of a transmitter according to an embodiment of the inventive concept.

FIG. 4 is a diagram of a transmitter according to an embodiment of the inventive concept.

FIG. 5 is a diagram illustrating an optical modulator based on a ring resonator according to an embodiment of the inventive concept.

FIG. 6 is a diagram illustrating an optical modulator based on a Michelson interferometer according to an embodiment of the inventive concept.

FIG. 7 is a diagram illustrating an optical modulator based on a Michelson interferometer according to an embodiment of the inventive concept.

FIG. 8 is a diagram illustrating an optical modulator based on a Sagnac interferometer according to an embodiment of the inventive concept.

FIG. 9 is a diagram illustrating an optical modulator based on a Mach-Zehnder interferometer according to an embodiment of the inventive concept.

FIG. 10 is a diagram illustrating an optical modulator based on a Mach-Zehnder interferometer according to an embodiment of the inventive concept.

FIG. 11 is a diagram illustrating a receiver according to an embodiment of the inventive concept.

FIG. 12A is a diagram illustrating an effect of a complementary signaling scheme of a optical interconnection device according to an embodiment of the inventive concept.

FIG. 12B is a diagram further illustrating the effect illustrated in FIG. 12A.

FIG. 13 is a flowchart illustrating a method of performing optical communication according to an embodiment of the inventive concept.

FIG. 14 is a block diagram illustrating a memory system comprising an optical interconnection device according to an embodiment of the inventive concept.

FIG. 15 is a diagram illustrating an example of the memory system of FIG. 14.

FIG. 16 is a diagram illustrating an operation of a power splitter in the memory system of FIG. 15.

FIG. 17 is a block diagram illustrating a memory system comprising an optical interconnection device according to an embodiment of the inventive concept.

FIG. 18 is a diagram illustrating a system according to an embodiment of the inventive concept.

FIG. 19 is a diagram illustrating an example of a memory module in the system of FIG. 18 according to an embodiment of the inventive concept.

FIG. 20 is a diagram further illustrating the memory module of FIG. 19.

FIG. 21 is a diagram illustrating another example of a memory module in the system of FIG. 18 according to an embodiment of the inventive concept.

FIG. 22 is a diagram further illustrating the memory module of FIG. 21.

FIG. 23 is a block diagram illustrating a computing system comprising a memory system according to an embodiment of the inventive concept.

### DETAILED DESCRIPTION

Embodiments of the inventive concept are described below with reference to the accompanying drawings. These embodiments are presented as teaching examples and should not be construed to limit the scope of the inventive concept.

In the description that follows, terms such as first, second, third etc. may be used to describe various features, but the described features should not be limited by these terms. Rather, these terms are used merely to distinguish one feature from another. Thus, a first feature discussed below could be termed a second feature without departing from the teachings of the inventive concept. As used herein, the term “and/or” includes any and all combinations of one or more of the associated listed items.

Where a feature is referred to as being “connected” or “coupled” to another feature, it can be directly connected or coupled to the other feature or intervening features may be present. In contrast, where a feature is referred to as being “directly connected” or “directly coupled” to another feature, there are no intervening features present. Other words used to describe the relationship between features should be interpreted in a like fashion (e.g., “between” versus “directly between,” “adjacent” versus “directly adjacent,” etc.).

The terminology used herein is for the purpose of describing embodiments only and is not intended to be limiting of the inventive concept. As used herein, the singular forms “a,” “an” and “the” are intended to include the plural forms as well, unless the context clearly indicates otherwise. Terms such as “comprises”, “comprising”, “includes”, “including”, etc., where used herein, specify the presence of stated features but do not preclude the presence or addition of one or more other features.

Unless otherwise defined, all terms (including technical and scientific terms) used herein have the same meaning as commonly understood by one of ordinary skill in the art. Terms such as those defined in commonly used dictionaries should be interpreted as having a meaning that is consistent with their meaning in the context of the relevant art and will not be interpreted in an idealized or overly formal sense unless expressly so defined herein.

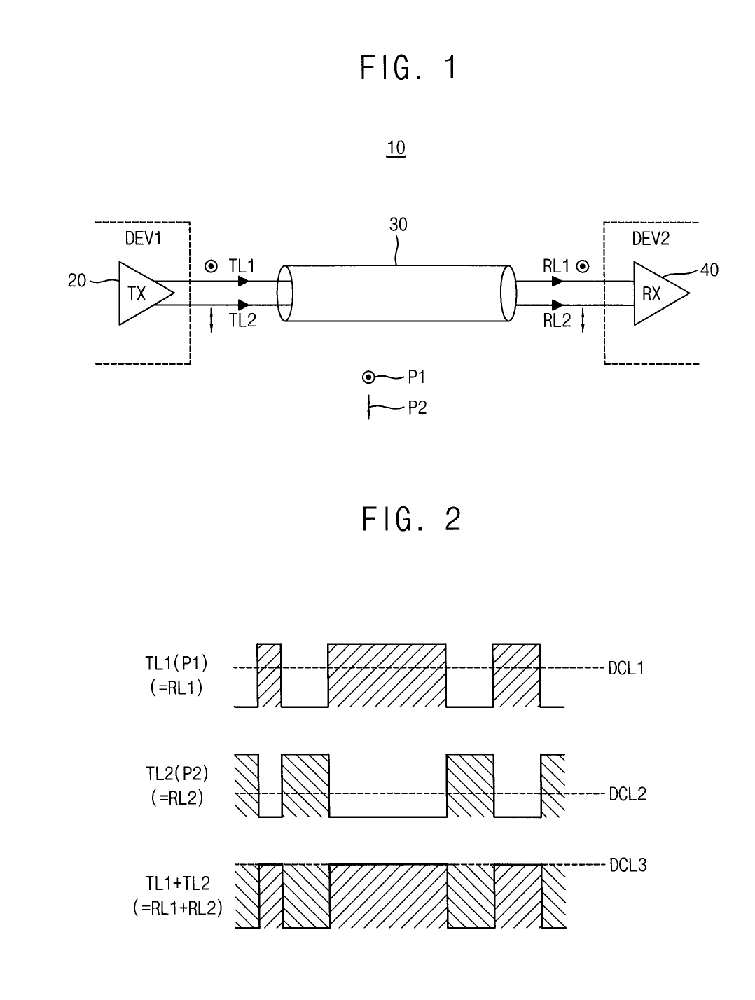

FIG. 1 is a diagram illustrating an optical interconnection device according to an embodiment of the inventive concept, and FIG. 2 is a diagram for describing a complementary signaling scheme of the optical interconnection device of FIG. 1.

Referring to FIG. 1, an optical interconnection device 10 comprises a transmitter TX 20, an optical waveguide 30 and a receiver RX 40. Transmitter 20 is disposed in a first device DEV1 and receiver 40 is disposed in a second device DEV2. First and second devices DEV1 and DEV2 may be, for instance, a memory controller and a memory device or a memory module.

Transmitter 20 generates first transmission light TL1 and second transmission light TL2, where first transmission light TL1 is linearly polarized with a first polarization P1, and second transmission light TL2 is linearly polarized with a second polarization P2 orthogonal to first polarization P1. First and second transmission light TL1 and TL2 have complementary data patterns. For instance, where first transmission light TL1 has a logic level “high”, second transmission light TL2 has a logic level “low”, and vice versa.

Hereinafter, for convenience description, a polarization perpendicular to a plane of incidence is referred to as a first polarization P1, which is represented in the figures as a dot surrounded by a circle, and a polarization parallel with the plane of incidence is referred to as a second polarization P2, which is represented in the figures as a double arrow. Accordingly first polarization P1 is orthogonal to second polarization P2. As examples, first polarization P1 may correspond to a transverse electric (TE) mode while second polarization P2 corresponds to a transverse magnetic (TM) mode, or vice versa.

First transmission light TL1 and second transmission light TL2 are transmitted concurrently through optical waveguide 30. Optical waveguide 30 may be a structure that is formed on or in a printed circuit board or an independent structure such as an optical fiber, for example. Optical waveguide 30 may be formed of polymer or dielectric material or optical waveguide 30 may be a hollow metal pipe. A cross-section of optical waveguide 30 may be a square, a rectangle, a circle, an ellipse or an arbitrary shape for guiding optical signals.

Receiver 40 receives first reception light RL1 corresponding to first transmission light TL1 and second reception light RL2 corresponding to second transmission light TL2 through optical waveguide 30. The transmission light and the reception light may be referred to as corresponding to each other where they have the same data pattern, e.g., where the transmission light is not changed substantially between transmission and reception. Where a loss through optical waveguide 30 is negligible, the transmission light and the corresponding reception light may be considered as being substantially the same.

Referring to FIG. 2, first transmission light TL1 and second transmission light TL2 have complementary data patterns. Two optical signals, e.g., first transmission light TL1 and second transmission light TL2 may be referred to as being complementary, if the power or intensity of first transmission light TL1 corresponds to a logic high level while the power of second transmission light TL2 corresponds to a logic low level, and vice versa.

As illustrated in FIG. 2, first transmission light TL1 has six bits of the logic low level and eight bits of the logic high level. In this case, the DC level DCL1 of first transmission light TL1 is higher than an average value of the logic high level and the logic low level. Second transmission light TL2 having the complementary data pattern may have eight bits of the logic low level and six bits of the logic high level, and thus the DC level DCL2 of second transmission light TL2 is lower than the average value of the logic high level and the logic low level.

The DC levels DCL1 and DCL2 of the first and second transmission lights TL1 and TL2 may be varied respectively depending on the data patterns. If the first and second transmission lights are complementary, the DC level DCL3 of the combined transmission lights TL1+TL2, which are transferred concurrently through optical waveguide 30, may be maintained at substantially the constant level. As such, a sum of powers of first transmission light TL1 and second transmission light TL2 may be constant regardless of the data pattern. In contrast, if the data pattern is transferred using only one of first transmission light TL1 and second transmission light TL2, the DC imbalance make it difficult to determine whether environmental fluctuation has occurred in the light received by receiver 40.

The power of the combined transmission lights TL1+TL2 may be maintained at a constant value by sending the complementary first and second transmission lights TL1 and TL2 concurrently through optical waveguide 30. In this case, if there occurs a variation in the power of the combined reception lights RL1+RL2, it can be determined that the variation is caused by the environmental fluctuations. Accordingly, based on the variation in the power of the combined reception lights RL1+RL2, the reception sensitivity of receiver 40, the driving strength of transmitter 20, etc. may be adjusted to achieve improved performance.

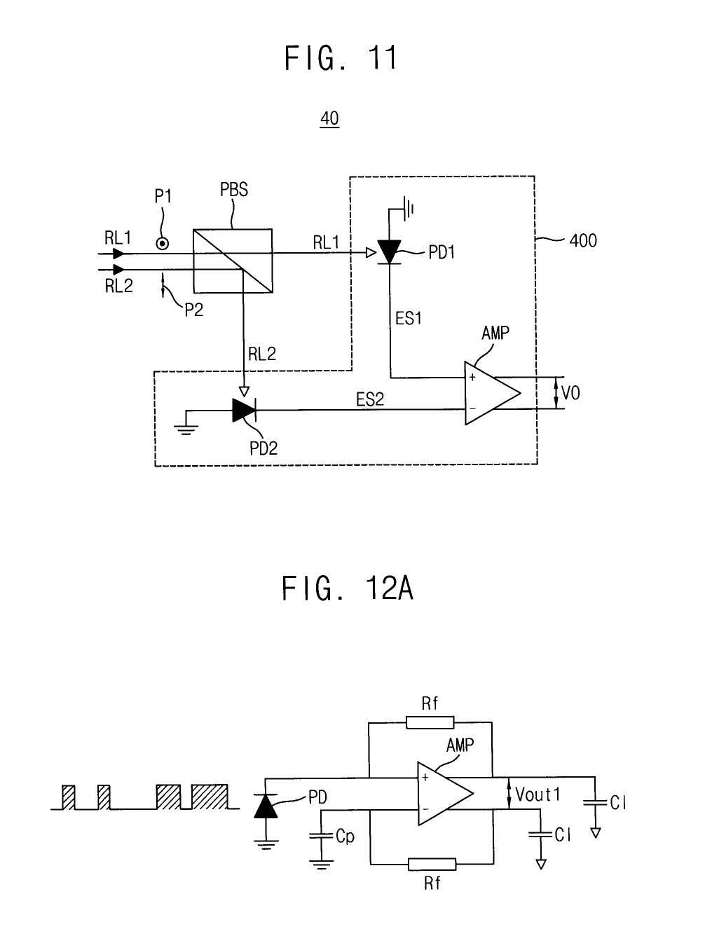

As described with reference to FIG. 11, receiver 40 may divide first and second reception lights RL1 and RL2 that are received concurrently and may perform differential amplification based on the divided first and second reception lights RL1 and RL2 to restore the data pattern. First transmission light TL1 and second transmission light TL2 have the orthogonal polarization for the differential amplification at receiver 40.

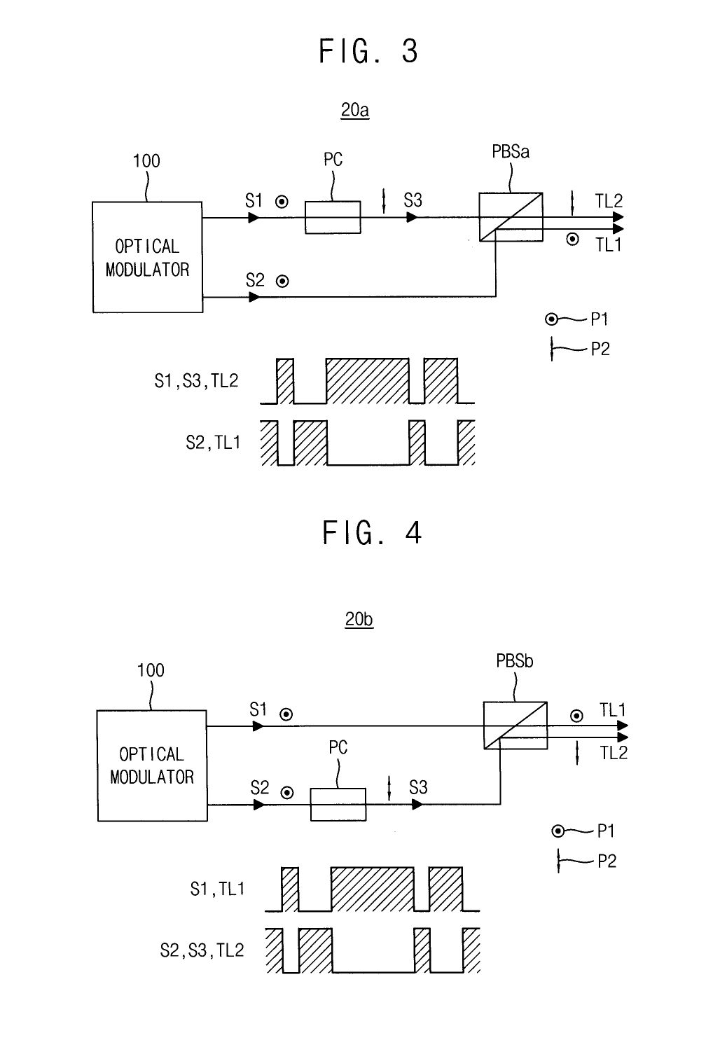

FIGS. 3 and 4 are diagrams illustrating a transmitter according to example embodiments.

Referring to FIG. 3, a transmitter 20a comprises an optical modulator 100, a polarization controller PC, and a polarization combiner PBSa.

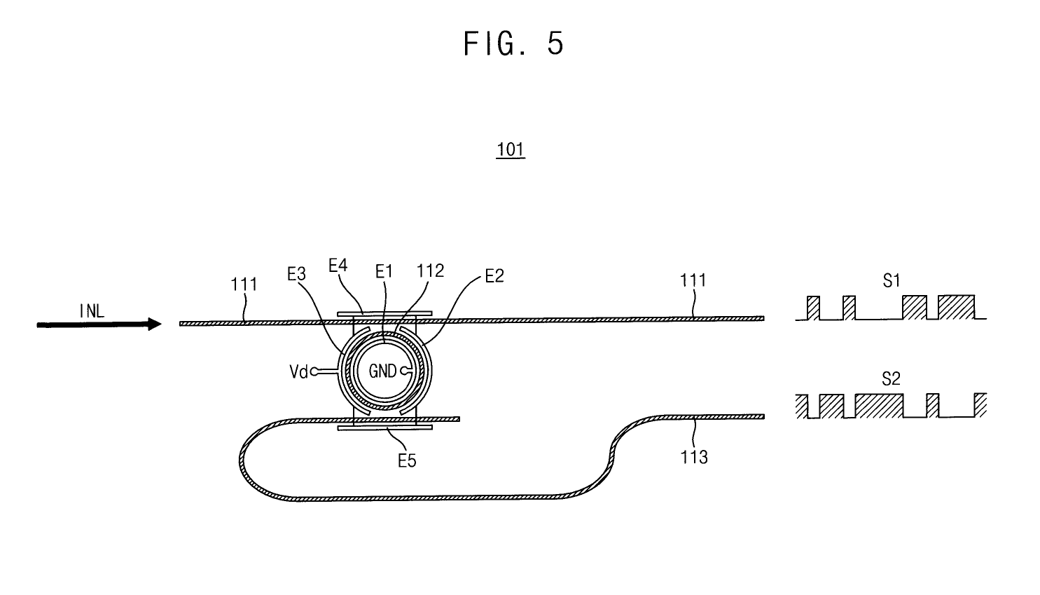

Optical modulator 100 generates a first modulated light S1 and a second modulated light S2 in response to a driving signal corresponding to a data pattern. The first and second modulated lights S1 and S2 have first polarization P1 commonly and data patterns complementary to each other. Further examples of the optical modulator are described below with reference to FIGS. 5 through 10.

Polarization controller PC generates a third modulated light S3 having second polarization P2 by rotating first polarization P1 of first modulated light S1 by 90 degrees.

Polarization combiner PBSa combines third modulated light S3 and second modulated light S2 to output first and second transmission lights TL1 and TL2 propagating in the same direction. As illustrated in FIG. 3, polarization combiner PBSa may be implemented with a polarization beam splitter that passes the light having second polarization P2 and reflects the light having first polarization P1.

Referring to FIG. 4, a transmitter 20b comprises an optical modulator 100, a polarization controller PC, and a polarization combiner PBSb.

Optical modulator 100 generates first modulated light S1 and second modulated light S2 in response to a driving signal corresponding to the data pattern. First and second modulated lights S1 and S2 have first polarization P1 commonly and the data patterns complementary to each other. Example embodiments of the optical modulator are described below with reference to FIGS. 5 through 10.

Polarization controller PC generates third modulated light S3 having second polarization P2 by rotating first polarization P1 of second modulated light S2 by 90 degrees.

Polarization combiner PBSb combine first modulated light S1 and third modulated light S3 to output first and second transmission lights TL1 and TL2 propagating in the same direction. As illustrated in FIG. 4, polarization combiner PBSb may be implemented with a polarization beam splitter that passes the light having first polarization P1 and reflects the light having second polarization P2.

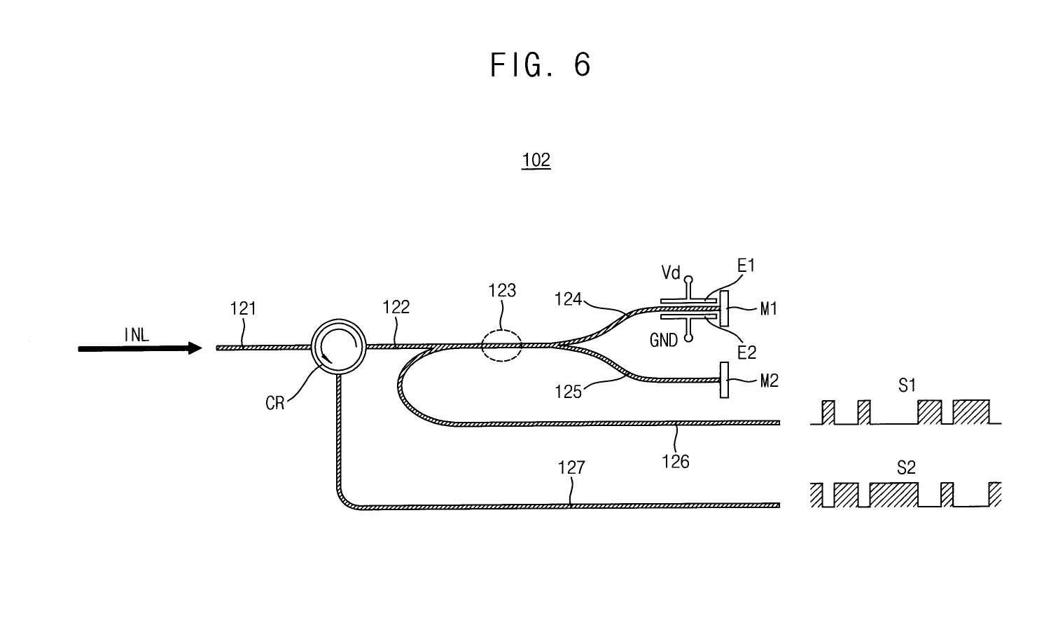

Hereinafter, example embodiments of an optical modulator are described with reference to FIGS. 5 through 10. Waveguides in FIGS. 5 through 10 may be optical waveguides, and two waveguide may be coupled to form one waveguide. For example, the beam coupler in FIG. 6 may be a directional coupler. In this case, second waveguide 122 and third waveguide 124 may be one continuous waveguide, and fourth waveguide 125 and fifth waveguide 126 may be another continuous waveguide.

FIG. 5 is a diagram illustrating an optical modulator based on a ring resonator according to an embodiment of the inventive concept.

Referring to FIG. 5, an optical modulator 101 comprises a first waveguide 111, a ring resonator 112, a second waveguide 113 and an electrode unit comprising electrodes E1 through E5.

First waveguide 111 receive an input light INL and optically-coupled to a first portion of ring resonator 112 to output first modulated light S1. Second waveguide 113 is optically-coupled to a second portion of ring resonator 112 to output second modulated light S2. As described above, first and second modulated lights S1 and S2 have the same polarization and the complementary data patterns. Electrodes E1 through E5 are disposed to apply the driving signal Vd to ring resonator 112. For example, as illustrated in FIG. 5, the electrode unit may include electrode E1 formed along the inner circumference of ring resonator 112 to apply a ground voltage GND and electrodes E2 through E5 formed along the outer circumference of the ring oscillator to apply driving signal Vd.

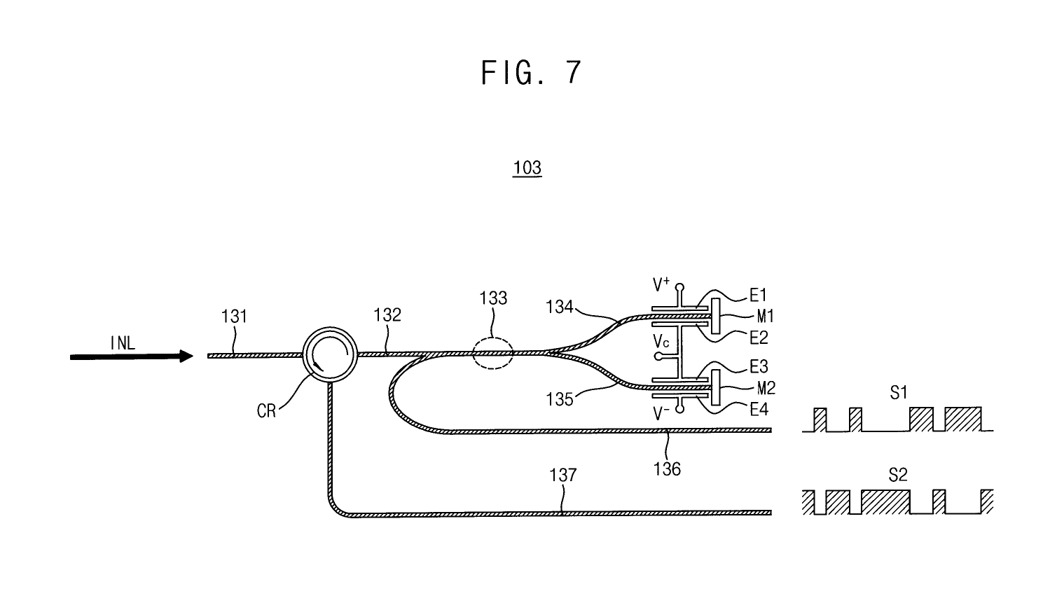

FIGS. 6 and 7 are diagrams illustrating an optical modulator based on a Michelson interferometer according to an embodiment of the inventive concept.

Referring to FIG. 6, an optical modulator 102 comprises a first waveguide 121, an optical circulator CR, a second waveguide 122, a beam coupler 123, a third waveguide 124, a fourth waveguide 125, a first reflector M1, a second reflector M2, a fifth waveguide 126, a sixth waveguide 127 and electrodes E1 and E2.

First waveguide 121 receives an input light INL and is coupled to an input port of optical circulator CR. Second waveguide 122 is coupled between a first output port of optical circulator CR and a first input end of beam coupler 123. Third waveguide 124 is coupled between a first output end of beam coupler 123 and first reflector M1. Fourth waveguide 125 is coupled between a second output end of beam coupler 123 and second reflector M2. Fifth waveguide 126 is coupled to a second input end of beam coupler 123 to output first modulated light S1. Sixth waveguide 127 is coupled to a second output port of optical circulator CR to output second modulated light S2. As described above, first and second modulated lights S1 and S2 have the same polarization and the complementary data patterns. Electrodes E1 and E2 are disposed to apply driving signal Vd to one of the third and fourth waveguides 124 and 125. For example, as illustrated in FIG. 6, the electrode unit may include electrode E1 to apply driving signal Vd to third waveguide 124 and electrode E2 to apply ground voltage GND to third waveguide 124.

Referring to FIG. 7, an optical modulator 103 comprises a first waveguide 131, an optical circulator CR, a second waveguide 132, a beam coupler 133, a third waveguide 134, a fourth waveguide 135, a first reflector M1, a second reflector M2, a fifth waveguide 136, a sixth waveguide 137 and an electrode unit comprising electrodes E1 through E4.

first waveguide 131 receives an input light INL and is coupled to an input port of optical circulator CR. Second waveguide 132 is coupled between a first output port of optical circulator CR and a first input end of beam coupler 133. Third waveguide 134 is coupled between a first output end of beam coupler 133 and first reflector M1. Fourth waveguide 135 is coupled between a second output end of beam coupler 133 and second reflector M2. Fifth waveguide 136 is coupled to a second input end of beam coupler 133 to output first modulated light S1. Sixth waveguide 137 is coupled to a second output port of optical circulator CR to output second modulated light S2.

As described above, first and second modulated lights S1 and S2 have the same polarization and the complementary data patterns. Electrodes E1 through E4 are disposed to apply driving signal V+ and an inversion signal V− of driving signal V+ to the third and fourth waveguides 134 and 135, respectively. For example, as illustrated in FIG. 7, the electrode unit may include electrode E1 to apply driving signal V+ to third waveguide 134, electrodes E2 and E3 to apply a common voltage Vc to the third and fourth waveguides 134 and 135, and electrode E4 apply inversion signal V− to fourth waveguide 135.

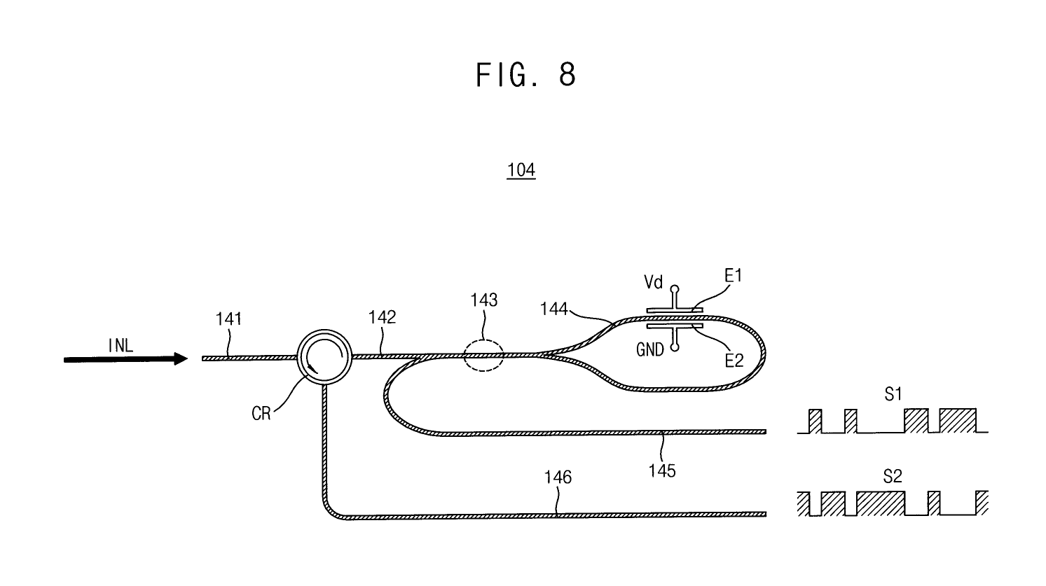

FIG. 8 is a diagram illustrating an optical modulator based on a Sagnac interferometer according to an embodiment of the inventive concept.

Referring to FIG. 8, an optical modulator 104 comprises a first waveguide 141, an optical circulator CR, a second waveguide 142, a beam coupler 143, a loop waveguide 144, a third waveguide 145, a fourth waveguide 146 and electrodes E1 and E2.

First waveguide 141 receives an input light INL and is coupled to an input port of optical circulator CR. Second waveguide 142 is coupled between a first output port of optical circulator CR and a first input end of beam coupler 143. Loop waveguide 144 is coupled between first and second output ends of beam coupler 143. Third waveguide 145 is coupled to a second input end of beam coupler 143 to output first modulated light S1. Fourth waveguide 146 is coupled to a second output port of optical circulator CR to output second modulated light S2. As described above, first and second modulated lights S1 and S2 have the same polarization and the complementary data patterns. Electrodes E1 and E2 are disposed to apply driving signal Vd to loop waveguide 144. For example, as illustrated in FIG. 8, the electrode unit may include electrode E1 to apply driving signal Vd to loop waveguide 144 and electrode E2 to apply ground voltage GND to loop waveguide 144.

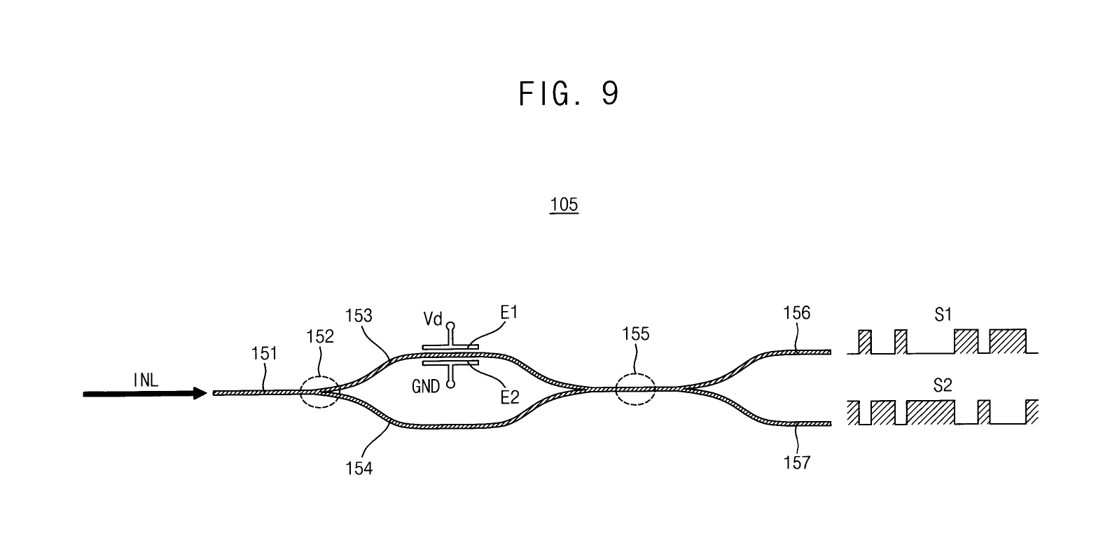

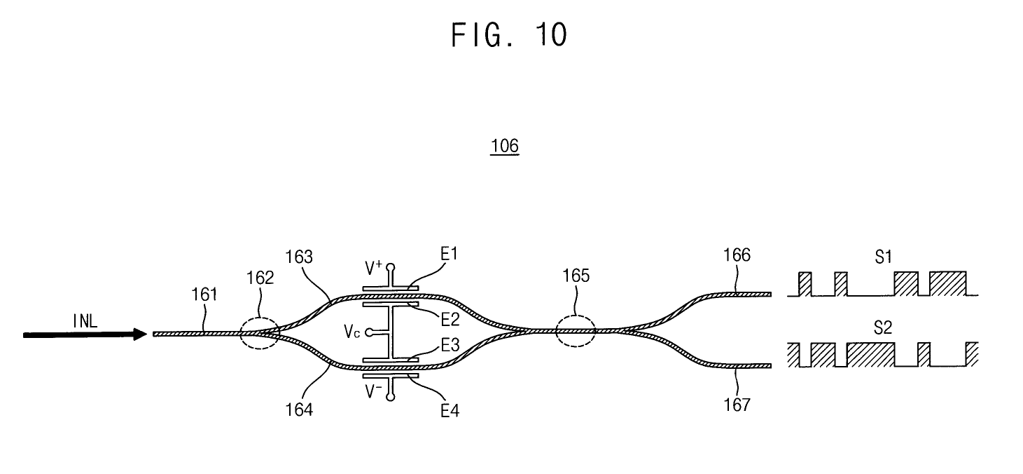

FIGS. 9 and 10 are diagrams illustrating an optical modulator based on a Mach-Zehnder interferometer according to an embodiment of the inventive concept.

Referring to FIG. 9, an optical modulator 105 comprises a first waveguide 151, a beam splitter 152, a second waveguide 153, a third waveguide 154, a beam coupler 155, a fourth waveguide 156, a fifth waveguide 157 and electrodes E1 and E2.

First waveguide 151 receives an input light INL and is coupled to an input end of beam splitter 152. Second waveguide 153 is coupled between a first output end of beam splitter 152 and a first input end of beam coupler 155. Third waveguide 154 is coupled between a second output end of beam splitter 152 and a second input end of beam coupler 155. Fourth waveguide 156 is coupled to a first output end of beam coupler 155 to output first modulated light S1. Fifth waveguide 157 is coupled to a second output end of beam coupler 155 to output second modulated light S2. As described above, first and second modulated lights S1 and S2 have the same polarization and the complementary data patterns. Electrodes E1 and E2 are disposed to apply driving signal Vd to one of the second and third waveguides 153 and 154. For example, as illustrated in FIG. 9, the electrode unit may include electrode E1 to apply driving signal Vd to second waveguide 153 and electrode E2 to apply ground voltage GND to second waveguide 153.

Referring to FIG. 10, an optical modulator 106 comprises a first waveguide 161, a beam splitter 162, a second waveguide 163, a third waveguide 164, a beam coupler 165, a fourth waveguide 166, a fifth waveguide 167, and an electrode unit comprising electrodes E1 through E4.

First waveguide 161 receives input light INL and is coupled to an input end of beam splitter 162. Second waveguide 163 is coupled between a first output end of beam splitter 162 and a first input end of beam coupler 165. Third waveguide 164 is coupled between a second output end of beam splitter 162 and a second input end of beam coupler 165. Fourth waveguide 166 is coupled to a first output end of beam coupler 165 to output first modulated light S1. Fifth waveguide 167 is coupled to a second output end of beam coupler 165 to output second modulated light S2. As described above, first and second modulated lights S1 and S2 have the same polarization and the complementary data patterns. Electrodes E1 through E4 are disposed to apply driving signal V+ and an inversion signal V− of driving signal V+ to the second and third waveguides 163 and 164, respectively. For example, as illustrated in FIG. 10, the electrode unit may include electrode E1 to apply driving signal V+ to second waveguide 163, electrodes E2 and E3 to apply a common voltage Vc to the second and third waveguides 163 and 164, and electrode E4 apply inversion signal V− to third waveguide 164.

As described with reference to FIGS. 5 through 10, optical modulators 101 through 106 may enhance power efficiency by generating the complementary first and second modulated lights S1 and S2. A transmitter using one of first and second modulated lights S1 and S2 outputs only a portion of the power of input light INL to the optical waveguide. In contrast, optical modulators 101 through 106 may output substantially the entire power of input light INL. As such, the optical interconnection device including optical modulators 101 through 106 may reduce power consumption by enhancing the modulation efficiency of the transmitter.

FIG. 11 is a diagram illustrating a receiver according to an embodiment of the inventive concept.

Referring to FIG. 11, a receiver 40 comprises a polarization beam splitter PBS and a photo-electric converter 400.

Polarization beam splitter PBS divides first and second reception lights RL1 and RL2 that are received concurrently through an optical waveguide. For example, as illustrated in FIG. 11, polarization beam splitter PBS may pass the first reception light RL1 having first polarization P1 and reflect the second reception light RL2 having second polarization P2 orthogonal to first polarization P1, to divide the combined reception lights RL1+RL2, which are received concurrently through the common optical waveguide, into the first and second reception lights RL1 and RL2.

Photo-electric converter 400 performs differential amplification based on the divided first and second reception lights RL1 land RL2 to generate an output signal VO corresponding to the data pattern transferred through reception lights RL1 and RL2. For example, photo-electric converter 400 may include a first photodiode PD1, a second photodiode PD2 and a differential amplifier AMP. First photodiode PD1 converts the first reception signal RL1 to a first electric signal ES1, and second photodiode PD2 converts the second reception signal RL2 to a second electric signal ES2. The differential amplifier generates output signal VO by amplifying a difference of the first and second electric signals ES1 and ES2.

As such, the optical interconnection device according to some embodiments may enhance reliability of transferred signals and reduce power consumption, by generating the two transmission lights having the orthogonal polarization and the complementary data patterns in a transmitter and by performing the complementary signaling of detecting the transferred data from the divided lights in the receiver.

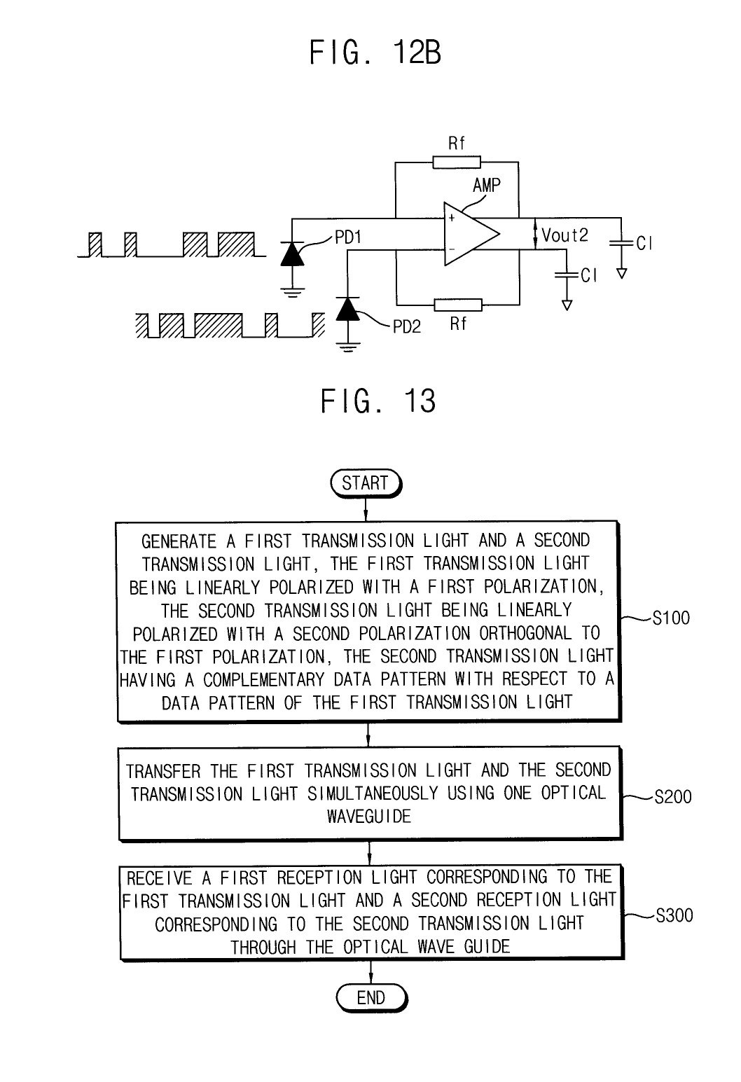

FIGS. 12A and 12B are diagrams for describing an effect of a complementary signaling scheme of an optical interconnection device according to an embodiment of the inventive concept.

FIG. 12A illustrates a receiver for a single-ended signaling using one transmission light and FIG. 12B illustrates a receiver for complementary or differential signaling using two complementary transmission lights according to example embodiments. The receiver of FIG. 12B comprises an input part of two photodiodes PD1 and PD2 whereas the receiver of FIG. 12A comprises an input part of one photodiode PD and one capacitor Cp. If the other components such a differential amplifier AMP, a load capacitors Cls, a feedback resistors Rfs, etc. are the same, the receiver of FIG. 12B may have a signal-to-noise ratio (SNR) enhanced by 6 dB with respect to the SNR of the receiver of FIG. 12B.

As such, power consumption may be reduced and reliability of transferred signals may be enhanced by performing complementary signaling according to example embodiments. In addition, the complementary signaling may be performed using one optical waveguide and thus the number of channels may be reduced to increase integration degree of systems.

FIG. 13 is a flowchart illustrating a method of performing optical communication according to an embodiment of the inventive concept.

Referring to FIG. 13, using the above-described transmitter 20, a first transmission light TL1 and a second transmission light TL2 are generated (S100), such that first transmission light TL1 is linearly polarized with a first polarization P1, second transmission light TL2 is linearly polarized with a second polarization P2 orthogonal to first polarization P1, and second transmission light TL2 has a data pattern that is complementary to a data pattern of first transmission light TL1. Using the one optical waveguide 30, first and second transmission lights TL1 and TL2 are transferred concurrently (S200). Using the above-described receiver 40, a first reception light RL1 corresponding to first transmission light TL1 and a second reception light RL2 corresponding to second transmission light TL2 are received (S300).

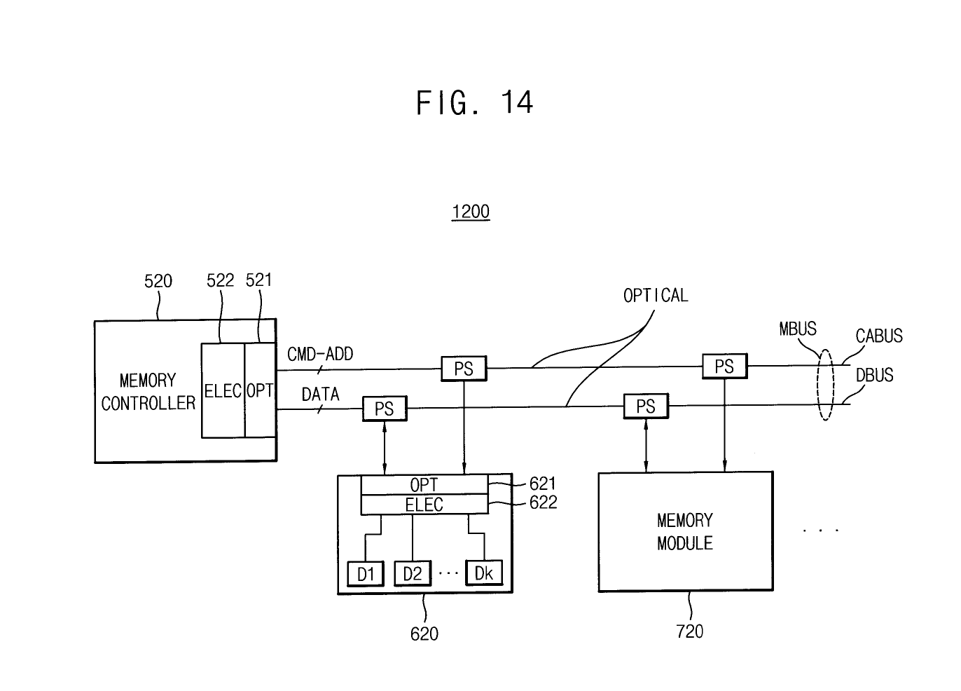

FIG. 14 is a block diagram illustrating a memory system comprising an optical interconnection device according to an embodiment of the inventive concept.

Referring to FIG. 14, a memory system 1200 comprises a memory controller 520, a plurality of memory modules 620 and 720 and a memory bus MBUS connecting memory controller 520 and memory modules 620 and 720. Memory modules 620 and 720 may have substantially the same configuration.

Memory controller 520 and memory module 620 comprise optical interfaces (OPT) 521 and 621 and electrical interfaces (ELEC) 522 and 622, respectively. Memory module 620 comprises a plurality of memory devices D1, D2 and Dk coupled to electrical interface 622.

Memory bus MBUS comprises a data bus DBUS implemented with at least one optical waveguide and a command-address bus CABUS implemented with at least one optical waveguide. Command-address signal CMD-ADD and data signal DATA transferred between memory controller 520 and memory modules 620 and 720 may be optical signals.

The transmitter and the receiver as described with reference to FIGS. 1 through 13 may be in interfaces 521, 522, 621 and 622 of memory controller 520 and memory module 620. The transmitter generates a first transmission light TL1 and a second transmission light TL2, where first transmission light TL1 is linearly polarized with a first polarization P1, second transmission light TL2 is linearly polarized with a second polarization P2 orthogonal to first polarization P1, and second transmission light TL2 has a complementary data pattern with respect to a data pattern of first transmission light TL1. First transmission light TL1 and second transmission light TL2 are transferred concurrently through one optical waveguide. The receiver receives a first reception light RL1 corresponding to first transmission light TL1 and a second reception light RL2 corresponding to second transmission light TL2 through the optical waveguide.

The channels of memory bus MBUS may be implemented with a broadcasting optical channel that is configured to transfer an optical signal concurrently to memory modules 620 and 720. The broadcasting optical channel may include an optical waveguide and a plurality of power splitters PSs sequentially inserted along the optical waveguide. Power splitters PSs are coupled to memory modules 620 and 720, respectively.

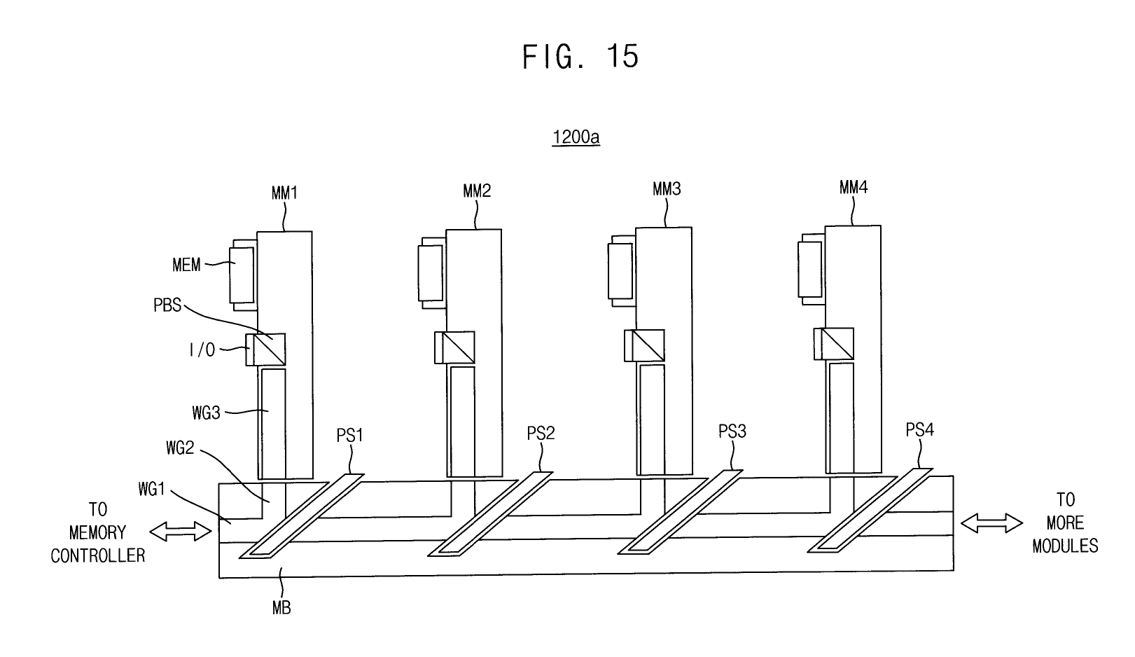

FIG. 15 is a diagram illustrating an example of the memory system of FIG. 14.

Referring to FIG. 15, a memory system 1200a comprises a main board MB, optical waveguides WG1 and WG2 and power splitters PS1 through PS4 formed in main board MB, and memory modules MM1 through MM4 mounted on main board MB. The memory controller is omitted in FIG. 15 for convenience of illustration. The horizontal optical waveguide WG1 connects the memory controller and power splitters PS1 through PS4, and the vertical optical waveguide WG2 connects the respective power splitter and the corresponding memory module. Each memory module may include an internal optical waveguide WG3 coupled to waveguide WG2 of main board MB, a polarization beam splitter PBS, an input-output unit I/O, at least one memory device MEM, etc.

The above-described optical interconnection device may further include a plurality of power splitters PS1 through PS4 as illustrated in FIG. 15, which are inserted along optical waveguide WG1 to transfer the transmission lights from the memory controller to memory modules MM1 through MM4. The memory controller may generate the transmission lights using lights of wavelengths different from each other for respectively communicating with memory modules MM1 through MM4. In this case, each of power splitters PS1 through PS4 may include a thin film filter configured to reflect a light of the corresponding wavelength among the wavelengths and pass lights of the other wavelengths.

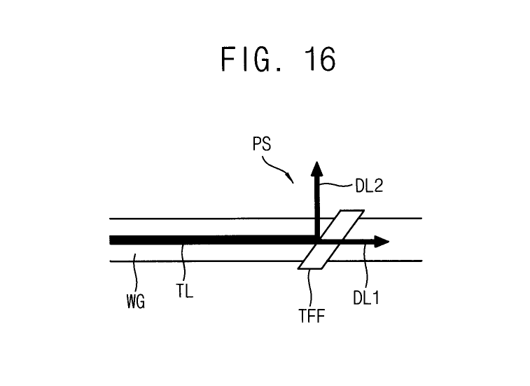

FIG. 16 is a diagram illustrating an operation of a power splitter in the memory system of FIG. 15.

Referring to FIG. 16, a power splitter PS may be implemented with a thin film filter TFF. Transmission light TL, which is transferred from the memory controller through optical waveguide WG, may be divided into a first light DL1 and a second light DL2. In other words, a portion of the power of transmission light TL may be transferred to the next power splitter and another portion of the power of transmission light TL may be transferred to the corresponding memory module. As described above, the thin film filter TFF may reflect a light of the particular wavelength and pass lights of the other wavelengths.

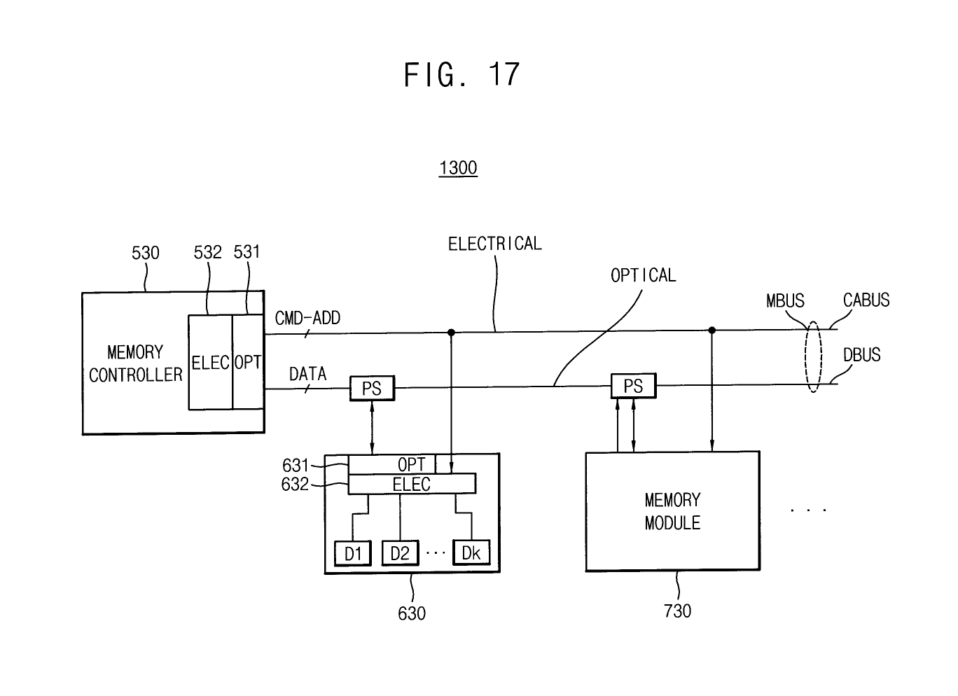

FIG. 17 is a block diagram illustrating a memory system comprising an optical interconnection device according to an embodiment of the inventive concept.

Referring to FIG. 17, a memory system 1300 comprises a memory controller 530, a plurality of memory modules 630 and 730 and a memory bus MBUS connecting memory controller 530 and memory modules 630 and 730. Memory modules 630 and 730 may have substantially the same configuration.

Memory controller 530 and memory module 630 comprise optical interfaces (OPT) 531 and 631 and electrical interfaces (ELEC) 532 and 632, respectively. Memory module 630 comprises a plurality of memory devices D1, D2 and Dk coupled to electrical interface 632.

Memory bus MBUS may include a data bus DBUS implemented with at least one optical waveguide and a command-address bus CABIS implemented with an electrical transmission line. Command-address signal CMD-ADD transferred between memory controller 530 and memory modules 603 and 730 may be electrical signals and data signal DATA transferred between memory controller 530 and memory modules 603 and 730 may be optical signals.

The transmitter and the receiver as described with reference to FIGS. 1 through 13 may be in interfaces 531, 532, 631 and 632 of memory controller 530 and memory module 630. The transmitter generates a first transmission light TL1 and a second transmission light TL2, where first transmission light TL1 is linearly polarized with a first polarization P1, second transmission light TL2 is linearly polarized with a second polarization P2 orthogonal to first polarization P1, and second transmission light TL2 has a complementary data pattern with respect to a data pattern of first transmission light TL1. First transmission light TL1 and second transmission light TL2 are transferred concurrently through one optical waveguide. The receiver receives a first reception light RL1 corresponding to first transmission light TL1 and a second reception light RL2 corresponding to second transmission light TL2 through the optical waveguide.

The channels of data bus DBUS may be implemented with a broadcasting optical channel that is configured to transfer an optical signal concurrently to memory modules 630 and 730. The broadcasting optical channel may include an optical waveguide and a plurality of power splitters PSs sequentially inserted along the optical waveguide. Power splitters PSs are coupled to memory modules 630 and 730, respectively.

FIG. 18 is a diagram illustrating a system according to an embodiment of the inventive concept.

Referring to FIG. 18, a system 1500 comprises a main board 900 such as a printed circuit board (PCB) and a memory system mounted on main board 900. The memory system comprises a memory controller 500, a plurality of memory modules 800 and a memory bus MBUS connecting memory controller 500 and memory modules 800. Memory modules 800 may be connected to memory bus MBUS detachably using sockets 80.

Even though only the memory system is illustrated in FIG. 18, various sub-systems may be mounted on main board 900. Memory controller 500 may be in an integrated circuit having various functions such as an application processor. Memory controller 500 and memory modules 900 may include optical interfaces for performing optical communication, respectively.

The transmitter and the receiver as described with reference to FIGS. 1 through 13 may be in the interfaces of memory controller 500 and memory modules 800.

As described above, a plurality of power splitters may be sequentially inserted along the optical waveguide coupled to memory controller 500. The optical waveguide may be formed on or in main board 900. The optical waveguide may be formed inside main board 90 or on the surface of main board 900. Where the optical waveguide is formed on the surface of main board 900, the power splitters may be formed inside sockets 80.

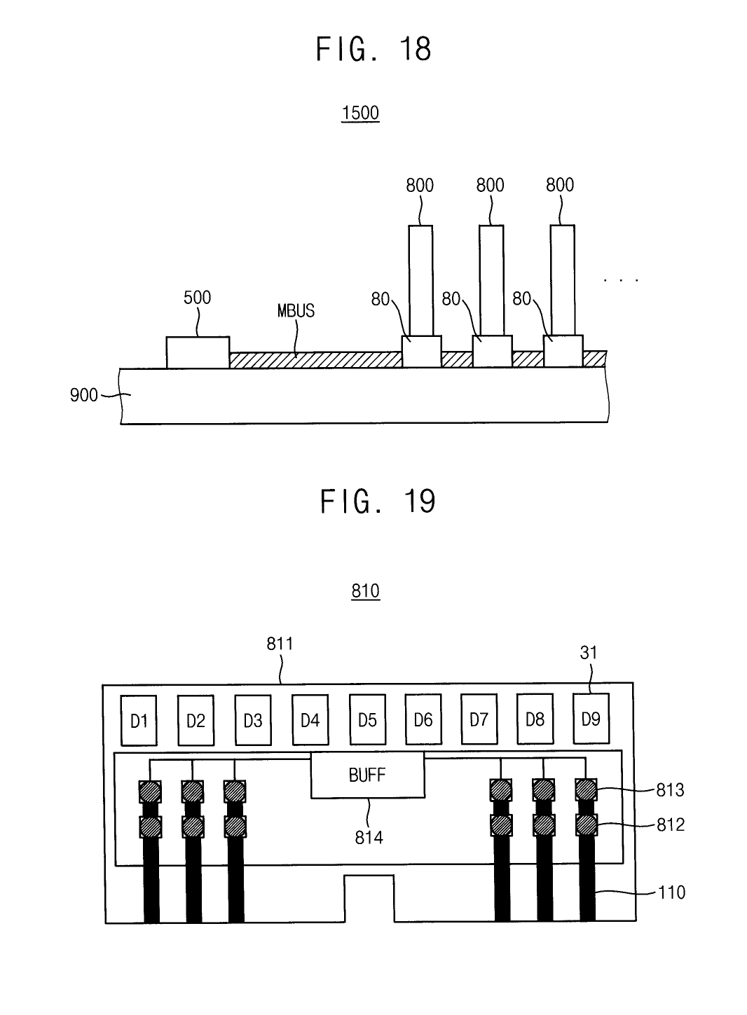

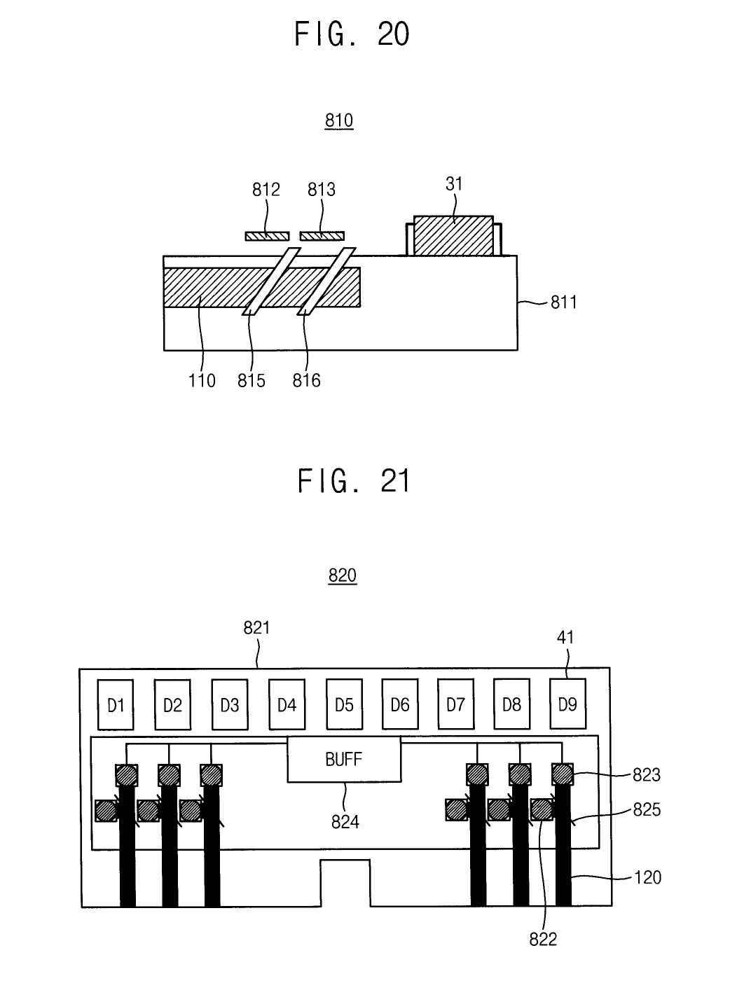

FIGS. 19 and 20 are diagrams illustrating an example of a memory module in the system of FIG. 18. FIG. 19 illustrates a top view of a memory module 810 and FIG. 20 illustrates a side view of memory module 810.

Referring to FIGS. 19 and 20, a memory module 810 comprises a plurality of memory devices (D1˜D9) 31, a buffer (BUFF) 814 coupled to memory devices 31, internal channels, and photo-detectors 812 and 813. Buffer 814 may correspond to the above-described electrical interface, and the photo-detectors 812 and 813 may be in the above-described optical interface. Each internal channel may include an internal optical waveguide 110, an input-output polarization beam splitter 815 and a reflector 816.

Even though nine memory devices 31 and six internal channels are illustrated in FIG. 19, the number of the memory devices and internal channels may be changed variously according to the design of the memory system. Memory devices 31 may include a DRAM, a mobile DRAM, an SRAM, a PRAM, an FRAM, an RRAM, an MRAM, etc.

As illustrated in FIGS. 19 and 20, photo-detectors 812 and 813 may be arranged in a line along the longitudinal direction of internal optical waveguide 110, for detecting the two complementary reception lights that are divided by the input-output polarization beam splitter 815. Input-output polarization beam splitter 815 and reflector 816 may be disposed under the photo-detectors 812 and 813, respectively.

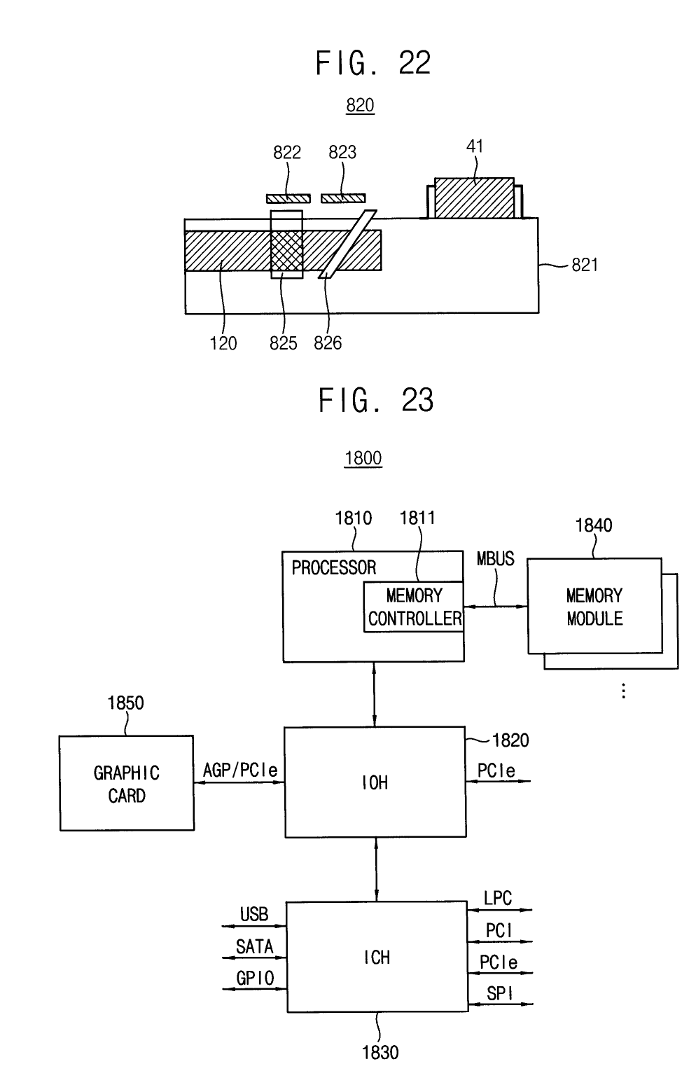

FIGS. 21 and 22 are diagrams illustrating another example of a memory module in the system of FIG. 18. FIG. 21 illustrates a top view of a memory module 820 and FIG. 22 illustrates a side view of memory module 820.

Referring to FIGS. 21 and 22, a memory module 820 may include a plurality of memory devices (D1˜D9) 41, a buffer (BUFF) 824 coupled to memory devices 41, internal channels, and photo-detectors 822 and 823. Buffer 824 may correspond to the above-described electrical interface, and the photo-detectors 822 and 823 may be in the above-described optical interface. Each internal channel may include an internal optical waveguide 120, an input-output polarization beam splitter 825 and a reflector 826.

Even though nine memory devices 41 and six internal channels are illustrated in FIG. 21, the numbers of the memory device and the internal channels may be changed variously according to the design of the memory system. Memory device 41 may include a dynamic random access memory (DRAM), a mobile DRAM, a static random access memory (SRAM), a phase-change random access memory (PRAM), a ferromagnetic random access memory (FRAM), a resistive random access memory (RRAM), a magnetic random access memory (MRAM), etc.

As illustrated in FIGS. 21 and 22, one photo-detector 823 may be arranged along the longitudinal direction of internal optical waveguide 120 and the other photo-detector 822 may be disposed at a side of internal optical waveguide 120. Reflectors may be disposed under the photo-detectors 822 and 823, respectively.

FIG. 23 is a block diagram illustrating a computing system including a memory system according to example embodiments.

Referring to FIG. 23, a computing system 1800 comprises a processor 1810, an input/output hub (IOH) 1820, an input/output controller hub (ICH) 1830, at least one memory module 1840 and a graphics card 1850. In some embodiments, computing system 1800 may be a personal computer (PC), a server computer, a workstation, a laptop computer, a mobile phone, a smart phone, a personal digital assistant (PDA), a portable multimedia player (PMP), a digital camera, a digital television, a set-top box, a music player, a portable game console, a navigation system, etc.

Processor 1810 may perform various computing functions, such as executing specific software for performing specific calculations or tasks. For example, processor 1810 may be a microprocessor, a central process unit (CPU), a digital signal processor, or the like. In some embodiments, processor 1810 may include a single core or multiple cores. For example, processor 1810 may be a multi-core processor, such as a dual-core processor, a quad-core processor, a hexa-core processor, etc. In some embodiments, computing system 1800 may include a plurality of processors. Processor 1810 may include an internal or external cache memory.

Processor 1810 comprises a memory controller 1811 for controlling operations of memory module 1840. Memory controller 1811 in processor 1810 may be referred to as an integrated memory controller (IMC). As described above, memory controller 1811 and memory modules 1840 may perform complementary signaling according to example embodiments.

In some embodiments, memory controller 1811 is located inside the input/output hub 1820, which may be referred to as memory controller hub (MCH). Each of memory modules 1840 may include a plurality of memory devices to store data provided from memory controller 1811.

Input/output hub 1820 may manage data transfer between processor 1810 and devices, such as graphics card 1850. Input/output hub 1820 may be coupled to processor 1810 via various interfaces. For example, the interface between processor 1810 and the input/output hub 1820 may be a front side bus (FSB), a system bus, a HyperTransport, a lightning data transport (LDT), a QuickPath interconnect (QPI), a common system interface (CSI), etc.

In some embodiments, computing system 1800 may include a plurality of input/output hubs. Input/output hub 1820 may provide various interfaces with the devices. For example, input/output hub 1820 may provide an accelerated graphics port (AGP) interface, a peripheral component interface-express (PCIe), a communications streaming architecture (CSA) interface, etc.

Graphics card 1850 may be coupled to the input/output hub 1820 via AGP or PCIe. Graphics card 1850 may control a display device (not shown) for displaying an image. Graphics card 1850 may include an internal processor for processing image data and an internal memory device. In some embodiments, input/output hub 1820 may include an internal graphics device along with or instead of graphics card 1850 outside graphics card 1850. The graphics device in input/output hub 1820 may be referred to as integrated graphics. Further, input/output hub 1820 including the internal memory controller and the internal graphics device may be referred to as a graphics and memory controller hub (GMCH).

Input/output controller hub 1830 may perform data buffering and interface arbitration to efficiently operate various system interfaces. Input/output controller hub 1830 may be coupled to the input/output hub 1820 via an internal bus, such as a direct media interface (DMI), a hub interface, an enterprise Southbridge interface (ESI), PCIe, etc. The input/output controller hub 1830 may provide various interfaces with peripheral devices. For example, the input/output controller hub 1830 may provide a universal serial bus (USB) port, a serial advanced technology attachment (SATA) port, a general purpose input/output (GPIO), a low pin count (LPC) bus, a serial peripheral interface (SPI), PCI, PCIe, etc.

In some embodiments, processor 1810, the input/output hub 1820 and the input/output controller hub 1830 may be implemented as separate chipsets or separate integrated circuits. In other embodiments, at least two of processor 1810, the input/output hub 1820 and the input/output controller hub 1830 may be implemented as a single chipset.

The components of computing system 1800 may be implemented with various packages. For example, at least a portion of the components of computing system 1800 may be mounted using packages or package configurations such as Package on Package (PoP), Ball grid arrays (BGAs), Chip scale package (CSP), Plastic Leaded Chip Carrier (PLCC), Plastic Dual In-Line Package (PDIP), Die in Waffle Package, Die in Wafer Form, Chip On Board (COB), Ceramic Dual In-Line Package (CERDIP), Plastic Metric Quad Flat Package (MQFP), Thin Quad Flat Package (TQFP), Shrink Small Outline Package (SSOP), Thin Small Outline Package (TSOP), System In Package (SIP), Multi Chip Package (MCP), Wafer-level Fabricated Package (WFP), Wafer-Level Processed Stack Package (WSP), etc.

As described above, an optical interconnection device, memory system, and method may reduce power consumption by enhancing the modulation efficiency of a transmitter. Reliability of the transferred signal may be enhanced by adopting complementary signaling, and the burst mode transfer of the memory system may be performed without additional data encoding. Furthermore the number of channels may be reduced by performing the complementary signaling using one optical waveguide, thereby realizing low-power and high-reliability optical communication without increasing the system size and the design burden.

Certain embodiments of the inventive concept may be applied usefully to a system operating in high-frequency environments to reduce power consumption and enhance reliability of transferred signals. For example, the inventive concept may be applied to systems such as a memory card, a solid state drive (SSD), a mobile phone, a smart phone, a personal digital assistant (PDA), a portable multimedia player (PMP), a digital camera, a music player, a portable game console, a navigation system, etc.

The foregoing is illustrative of example embodiments and is not to be construed as limiting thereof. Although a few example embodiments have been described, those skilled in the art will readily appreciate that many modifications are possible in the example embodiments without materially departing from the scope of the inventive concept. Accordingly, all such modifications are intended to be included within the scope of the inventive concept as defined in the claims.

What is claimed is:

1. An optical interconnection device comprising:
a transmitter configured to generate first transmission light with a first data pattern and second transmission light with a second data pattern, the first and second data patterns being derived from an original data pattern, the first transmission light being linearly polarized with a first polarization, the second transmission light being linearly polarized with a second polarization orthogonal to the first polarization, and the first and second data patterns being complementary to each other;
an optical waveguide configured to communicate the first transmission light and the second transmission light concurrently; and
a receiver configured to receive first reception light corresponding to the first transmission light and second reception light corresponding to the second transmission light through the optical waveguide.

2. The optical interconnection device of claim 1, wherein a sum of a power of the first transmission light and a power of the second transmission light is substantially constant regardless of the original data pattern.

3. The optical interconnection device of claim 1, wherein the receiver is configured to receive the first and second reception lights concurrently, to divide the received first and second reception lights, and to perform differential amplification based on the divided first and second reception lights to restore the original data pattern.

4. The optical interconnection device of claim 1, wherein the transmitter comprises:
an optical modulator configured to generate first modulated light and second modulated light in response to a driving signal corresponding to the original data pattern, the first and second modulated lights both having the first polarization and having data patterns complementary to each other;
a polarization controller configured to generate a third modulated light having the second polarization by rotating the first polarization of one of the first and second modulated lights by 90 degrees; and
a polarization combiner configured to combine the third modulated light and the other of the first and second modulated lights to output the first and second transmission lights propagating in the same direction.

5. The optical interconnection device of claim 4, wherein the optical modulator comprises:
a ring resonator;
a first waveguide configured to receive input light and optically-coupled to a first portion of the ring resonator to output the first modulated light;
a second waveguide optically-coupled to a second portion of the ring resonator to output the second modulated light; and
an electrode unit configured to apply the driving signal to the ring resonator.

6. The optical interconnection device of claim 4, wherein the optical modulator comprises:
an optical circulator;
a beam coupler;
a first reflector;
a second reflector;
a first waveguide configured to receive input light and coupled to an input port of the optical circulator;
a second waveguide coupled between a first output port of the optical circulator and a first input end of the beam coupler;
a third waveguide coupled between a first output end of the beam coupler and the first reflector;
a fourth waveguide coupled between a second output end of the beam coupler and the second reflector;
a fifth waveguide coupled to a second input end of the beam coupler to output the first modulated light;
a sixth waveguide coupled to a second output port of the optical circulator to output the second modulated light; and
an electrode unit configured to apply the driving signal to one of the third and fourth waveguides.

7. The optical interconnection device of claim 4, wherein the optical modulator comprises:
an optical circulator;
a beam coupler;
a first reflector;
a second reflector;
a first waveguide configured to receive an input light and coupled to an input port of the optical circulator;
a second waveguide coupled between a first output port of the optical circulator and a first input end of the beam coupler;
a third waveguide coupled between a first output end of the beam coupler and the first reflector;
a fourth waveguide coupled between a second output end of the beam coupler and the second reflector;
a fifth waveguide coupled to a second input end of the beam coupler to output the first modulated light;
a sixth waveguide coupled to a second output port of the optical circulator to output the second modulated light; and
an electrode unit configured to apply the driving signal and an inverted driving signal to the third and fourth waveguides, respectively.

8. The optical interconnection device of claim 4, wherein the optical modulator comprises:
an optical circulator;
a beam coupler;
a first waveguide configured to receive input light and coupled to an input port of the optical circulator;
a second waveguide coupled between a first output port of the optical circulator and a first input end of the beam coupler;
a loop waveguide coupled between first and second output ends of the beam coupler;
a third waveguide coupled to a second input end of the beam coupler to output the first modulated light;
a fourth waveguide coupled to a second output port of the optical circulator to output the second modulated light; and
an electrode unit configured to apply the driving signal to the loop waveguide.

9. The optical interconnection device of claim 4, wherein the optical modulator includes:
a beam splitter;
a beam coupler;
a first waveguide configured to receive input light and coupled to an input end of the beam splitter;
a second waveguide coupled between a first output end of the beam splitter and a first input end of the beam coupler;
a third waveguide coupled between a second output end of the beam splitter and a second input end of the beam coupler;
a fourth waveguide coupled to a first output end of the beam coupler to output the first modulated light;
a fifth waveguide coupled to a second output end of the beam coupler to output the second modulated light; and
an electrode unit configured to apply the driving signal to one of the second and third waveguides.

10. The optical interconnection device of claim 4, wherein the optical modulator comprises:
a beam splitter;
a beam coupler;
a first waveguide configured to receive input light and coupled to an input end of the beam splitter;
a second waveguide coupled between a first output end of the beam splitter and a first input end of the beam coupler;
a third waveguide coupled between a second output end of the beam splitter and a second input end of the beam coupler;
a fourth waveguide coupled to a first output end of the beam coupler to output the first modulated light;
a fifth waveguide coupled to a second output end of the beam coupler to output the second modulated light; and
an electrode unit configured to apply the driving signal and an inversion driving signal to the second and third waveguides, respectively.

11. The optical interconnection device of claim 4, wherein the receiver comprises:
a polarization beam splitter configured to divide the first and second reception lights, which are received concurrently through the optical waveguide; and
a photo-electric converter configured to perform differential amplification based on the divided first and second reception lights to generate an output signal corresponding to the original data pattern.

12. The optical interconnection device of claim 11, wherein the photo-electric converter includes:
a first photodiode configured to convert the first reception signal to a first electric signal;
a second photodiode configured to convert the second reception signal to a second electric signal; and
a differential amplifier configured to generate the output signal by amplifying a difference of the first and second electric signals.

13. A memory system comprising:
a memory controller;
one or more memory modules; and
one or more optical interconnection devices each comprising:
a transmitter configured to generate first transmission light with a first data pattern and second transmission light with a second data pattern, the first and second data patterns being derived from an original data pattern, the first transmission light being linearly polarized with a first polarization, the second transmission light being linearly polarized with a second polarization orthogonal to the first polarization, and the first and second data patterns being complementary to each other;
an optical waveguide configured to communicate the first transmission light and the second transmission light concurrently; and
a receiver configured to receive first reception light corresponding to the first transmission light and second reception light corresponding to the second transmission light through the optical waveguide.

14. The memory system of claim 13, wherein at least one of the optical interconnection devices further comprises a plurality of power splitters inserted along the optical waveguide, the power splitters being configured to transfer the first and second transmission lights from the memory controller to the memory modules.

15. The memory system of claim 14, wherein the memory controller is configured to generate the first and second transmission lights using lights of wavelengths different from each other for respectively communicating with the memory modules, and
wherein each power splitter comprises a thin film filter configured to reflect a light of the corresponding wavelength among the wavelengths and pass lights of the other wavelengths.

16. A method, comprising:
generating first transmission light with a first data pattern and second transmission light with a second data pattern, the first and second data patterns being derived from an original data pattern, the first transmission light being linearly polarized with a first polarization, the second transmission light being linearly polarized with a second polarization orthogonal to the first polarization, and the first and second data patterns being complementary to each other;
communicating the first transmission light and the second transmission light concurrently through an optical waveguide; and
receiving first reception light corresponding to the first transmission light and second reception light corresponding to the second transmission light through the optical waveguide.

17. The method of claim 16, wherein a sum of a power of the first transmission light and a power of the second transmission light is substantially constant regardless of the original data pattern.

18. The method claim 16, further comprising receiving the first and second reception lights concurrently, dividing the received first and second reception lights, and performing differential amplification based on the divided first and second reception lights to restore the original data pattern.

19. The method of claim 16, further comprising:
operating an optical modulator to generate first modulated light and second modulated light in response to a driving signal corresponding to the original data pattern, the first and second modulated lights both having the first polarization and having data patterns complementary to each other;
operating a polarization controller to generate a third modulated light having the second polarization by rotating the first polarization of one of the first and second modulated lights by 90 degrees; and
operating a polarization combiner to combine the third modulated light and the other of the first and second modulated lights to output the first and second transmission lights propagating in the same direction.

20. The method of claim 19, wherein the optical modulator comprises:
a ring resonator;
a first waveguide configured to receive input light and optically-coupled to a first portion of the ring resonator to output the first modulated light;
a second waveguide optically-coupled to a second portion of the ring resonator to output the second modulated light; and
an electrode unit configured to apply the driving signal to the ring resonator.
